(19) United States
(12) Patent Application Publication
(10) Pub. No.: US 2017/0043733 A1
(43) Pub. Date: Feb. 16, 2017

(54) METHOD FOR MANAGING THE POWER SUPPLY OF DISPLAY SCREENS ON BOARD A MOTOR VEHICLE

(71) Applicant: RENAULT s.a.s., Boulogne Billancourt (FR)

(72) Inventors: Denis D. BLANDIN, Guyancourt (FR); Solen KERLEROUX-MAYERE, Cernay La Ville (FR)

(73) Assignee: RENAULT s.a.s., Boulogne Billancourt (FR)

(21) Appl. No.: 15/305,997

(22) PCT Filed: Apr. 9, 2015
(86) PCT No.: PCT/FR2015/050953

§ 371 Date: Oct. 21, 2016

(30) Foreign Application Priority Data
Apr. 22, 2014 (FR) 1453581

(51) Int. Cl. B60R 16/033; H02J 7/14; B60K 35/00

(52) U.S. Cl. CPC B60R 16/033; B60K 35/00; H02J 7/1438; B60K 2350/352

(57) ABSTRACT

A method manages a power supply of display screens on board a motor vehicle. The vehicle includes an onboard electric battery, at least one vehicle starting device that is supplied with electricity by the battery, the starting device being operational only when powered by a voltage greater than or equal to an activation threshold, at least one main screen powered by the battery, at least one accessory screen powered by the battery, and an electronic control unit that determine the voltage level of the battery at all times. The method includes switching off the at least one accessory screen by the electronic control unit when the voltage level of the battery is less than a first specified threshold of extinction, the first threshold of extinction being greater than the activation threshold.

### TECHNICAL FIELD OF THE INVENTION

The invention relates to a method for managing the power supply of display screens on board a motor vehicle.

### BACKGROUND OF THE INVENTION

The invention more particularly relates to a method for managing the power supply of display screens on board a motor vehicle, said motor vehicle including:
an onboard electric battery;
at least one vehicle starting device that is supplied with electricity by the battery, the starting device being operational only when powered by a voltage greater than or equal to its activation threshold;
at least one main screen arranged facing the driver that displays information essential for vehicle operation, the main screen being powered by the battery;
at least one accessory screen that displays information that is not essential to vehicle operation, the accessory screen being powered by the battery;
an electronic control unit that is likely to determine the voltage level of the battery at all times.

Current technology allows digital flat screens to be produced that are very small in size, notably in terms of thickness. This allows large-size screens to be built into the passenger compartment of the motor vehicle, and notably into the dashboard.

It is known to use such screens to display important driving information such as speed, fuel tank level or any other information that is generally displayed by dials. Such a so-called “main” screen is, for example, arranged behind the steering wheel, in the driver's field of vision.

Accessory screens are also used to perform secondary functions, e.g. display of radio stations, a GPS map, and status of the vehicle air conditioning system. Such a screen often has a touchscreen function that allows the driver or the passenger to control the functions displayed. This screen is usually arranged between the driver's seat and the passengers seat.

Other accessory screens are also arranged in front of the passengers. These screens do not fulfill any function relating to vehicle operation or to the control of an accessory of the vehicle. They allow passengers to enjoy various functions, such as watching a movie, surfing the Internet, checking e-mail, etc.

However, these screens are powered by the vehicle battery. If not properly managed, this energy consumption may drain the battery to the point of causing a vehicle breakdown, particularly being no longer able to sufficiently supply an electric starter.

### BRIEF SUMMARY OF THE INVENTION

The present invention proposes a management method of the type described above, characterized in that when the voltage level of the battery is below a first specified threshold of extinction, at least one accessory screen is switched off by the electronic control unit, the first threshold of extinction being greater than the activation threshold.

According to other features of the method:
the vehicle includes at least a second accessory screen, when the voltage level of the battery is below a second specified threshold of extinction, the second accessory screen is switched off by the electronic control unit, the second threshold of extinction being between the first specified threshold of extinction and the activation threshold;
when the voltage level of the battery is below a third specified threshold of extinction, all the screens are switched off by the electronic control unit;
the third specified threshold of extinction is less than all the other specified thresholds of extinction;
when the voltage level of the battery is lower than a specified dimming threshold, the light intensity of the accessory screens is reduced by the electronic control unit, the specified dimming threshold being higher than the thresholds of extinction;
when the voltage level of the battery is below the specified dimming threshold, the light intensity of the main screens is reduced by the electronic control unit;
the intensity of at least one screen is reduced proportionally to the decrease in the voltage of the battery level from the dimming threshold to the associated threshold of extinction;
the brightness of at least one screen is reduced by sectors, the darkened area of each screen being generally proportional to the voltage drop of the battery from the dimming threshold to the associated threshold of extinction.

### BRIEF DESCRIPTION OF FIGURES

Other features and advantages of the invention will emerge more clearly on reading the detailed description that follows in reference to the accompanying drawings in which:

FIG. 1 is a front view that schematically represents a motor vehicle dashboard including display screens;

FIG. 2 is a block diagram showing a method for managing the electrical power supply of the display screens of FIG. 1.

### DETAILED DESCRIPTION OF THE FIGURES

For the remainder of the description, elements having an identical structure or similar functions shall be designated by the same reference.

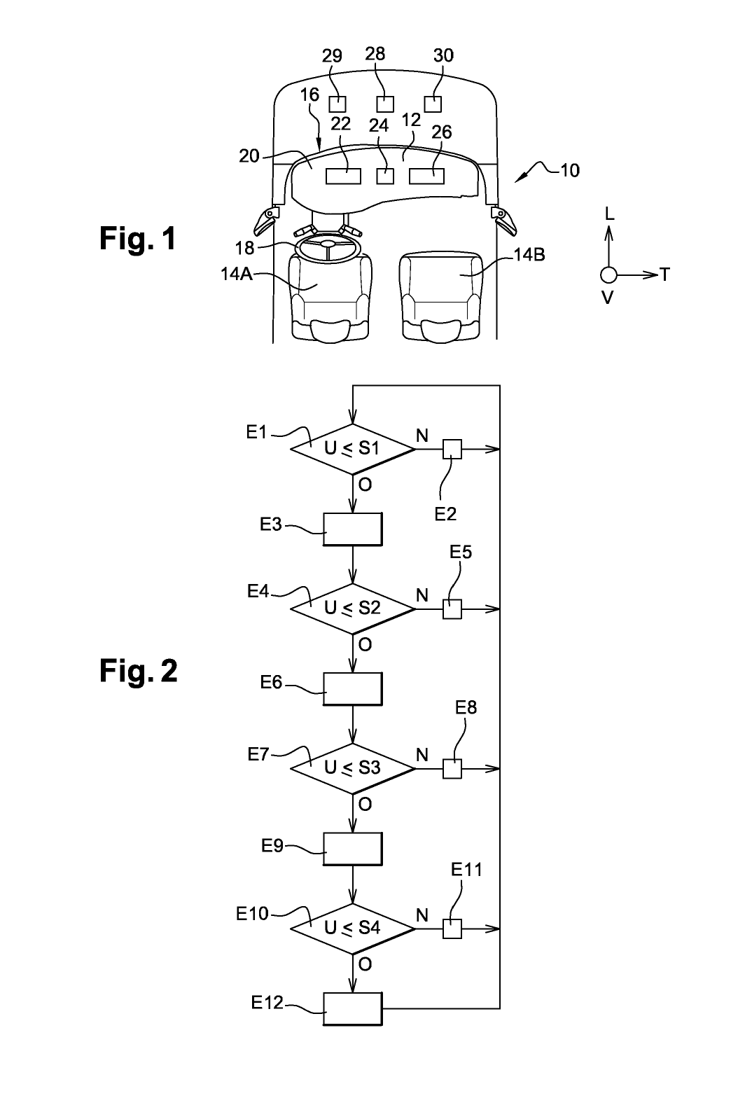

For the remainder of the description, the longitudinal, vertical and transversal orientations, indicated by the trihedral “L, V, T” of FIG. 1, shall be adopted in a non-limiting manner.

FIG. 1 represents the front of a passenger compartment 10 of a moving motor vehicle. The passenger compartment 10 is crossed by a transversal dashboard 12.

The passenger compartment 10 also includes at least one transversal row of front seats which are arranged longitudinally behind the dashboard 12. The seats are arranged transversely side by side so that their occupants are facing forward, facing the dashboard 12.

In the example shown in FIG. 1, the left seat 14A is intended for the driver of the vehicle. The right seat 14B is intended for a passenger of the vehicle.

Facing the driver seat 14A, the left side of the dashboard 12 includes a driving position 16 which is generally equipped with a steering wheel 18 and an instrument panel 20. The instrument panel 20 includes a main display screen 22 that displays information essential for vehicle operation. For example, the main screen 22 displays the speed of travel of the vehicle, the fuel gauge, or any other information regarding vehicle operation.

Between the two front seats 14A, 14B, it is known to arrange various vehicle comfort control functions, e.g. air conditioning control, the audio system or a “GPS”. In the embodiment shown in FIG. 1, these functions are at least partially filled by a first accessory display screen 24. This is, for example, a touch screen 24 that allows the driver or passenger to control the various functions listed above. The first accessory screen 24 displays information that is incidental to vehicle operation, but concerns information used to control certain vehicle comfort functions. This accessory screen 24 will be referred to hereinafter as the “comfort screen 24”.

Facing the passenger seat 14B, the right part of the dashboard 12 includes a second accessory display screen 26 which is arranged longitudinally opposite the passenger seat 14B. The second accessory screen 26 is intended to display information unrelated to vehicle operation. This screen 26 allows the passenger to browse the internet or to watch movies. The second accessory screen 26 displays information unrelated to vehicle operation or any vehicle function. This accessory screen 26 will be referred to hereinafter as the “recreational screen 26”.

These screens 22, 24, 26 can be ranked according to the importance of the information displayed for vehicle use. The main screen 22 is ranked in first position as it displays the most important information for vehicle operation. The comfort screen 24 is ranked second because it displays information for using vehicle accessories or driver assistance applications, notably the “GPS”. Finally, the recreational screen 26 is ranked in last position as it does not provide vehicle-related information.

The display screens 22, 24, 26 are of “flat screen” type. It is, for example, a liquid crystal display, commonly known by the acronym “LCD”, or an electroluminescent panel, commonly known by the acronym “OLED” (Organic Light-Emitting Diode). As such displays are widely known, their structure will not be described in further detail hereinafter.

Each display screen 22, 24, 26 is built into the dashboard 12. Each display screen 22, 24, 26 is built into and permanently secured in a housing provided for this purpose in the dashboard 12 of the vehicle.

Alternatively, the vehicle includes other recreational screens, e.g. screens embedded in the seatback of the front seats, facing passengers in the back of the vehicle.

Conventionally, the vehicle also includes an onboard storage battery 28. This battery 28 is intended to supply various vehicle components of the vehicle, e.g. the headlights, audio system, etc.

As this is a vehicle with an internal combustion engine, the battery 28 also provides power to a vehicle starting device 29, e.g. a starter or starter-alternator. The starting device 29 is adapted to start the engine of the vehicle only when powered by the battery 28 with a “U” voltage greater than or equal to an activation threshold “Sa”. Below this activation threshold “Sa”, the starting device 29 does not deliver sufficient mechanical power to start the combustion engine.

The battery 28 also provides power to the main screen 22 and the accessory screens 24, 26.

The vehicle also includes a electronic control unit 30 which is capable of determining the voltage level “U” of the battery 28 at all times, through measurement or estimate.

It was found that the display screens 22, 24, 26 were likely to consume an excessive amount of electrical power. In certain cases, the electricity consumption is likely to at least partially discharge the battery 28. When the battery 28 has a voltage level “U” below the activation threshold “Sa” of the starting device, when the engine of the vehicle is switched off, the starting device can not restart the engine. The vehicle is thus immobilized.

To solve this problem, the invention proposes a method for managing the electrical power supply of the display screens 22, 24, 26 according to the charge status of the battery 28, and notably according to the voltage level “U” determined by the electronic control unit 30. Such a method is illustrated in FIG. 2.

In a first verification step “E1”, the electronic control unit 30 determines if the voltage level “U” of the battery is below a specified dimming threshold “S1”. The specified dimming threshold “S1” is greater than the activation threshold “Sa”. The dimming threshold “S1” is equal to 11.5 V, for example.

If this is not the case, it is estimated that the battery 28 is still sufficiently charged to supply the screens 22, 24, 26 without risk for the power supply of the starting device. The method is reiterated from the beginning without action on the screens 22, 24, 26.

If needed, prior to reiteration, a second reset step “E2” is implemented to switch on the screens 22, 24, 26 with their normal brightness level, the extinction of which was forced during a previous iteration of the method.

If this is the case, this means that the voltage level “U” of the battery is below the dimming threshold “S1”. In this case, the light intensity at least of the accessory screens 22, 24 is reduced by the electronic control unit during a third reduction step “E3”. It is estimated that this reduction in intensity should be sufficient to maintain the battery 28 at a voltage level “U” sufficient to activate the starting device the next time the vehicle is started.

In the method shown in FIG. 2, the light intensity of the main screen 22 is also reduced by the electronic control unit 30 during this third reduction stage “E3”.

According to a non-represented variant of the invention, the electronic control unit reduces the light intensity when the voltage level of the battery falls below a second dimming threshold. This second dimming threshold being less than the dimming threshold “S1” of the accessory screens.

The method then proceeds to a fourth verification step “E4”. During this fourth step “E4”, the electronic control unit 30 determines if the voltage level “U” of the battery is less than a first specified threshold of extinction “S2”. The first threshold of extinction “S2” is less than the dimming threshold “S1”, and greater than the activation threshold “Sa”. The first threshold of extinction “S2” is equal to 11.3 V, for example.

If this is not the case, it is estimated that the battery 28 is still sufficiently charged to supply the screens 22, 24, 26 without risk for the power supply of the starting device. The method is thus reiterated from the beginning without other action on the screens 22, 24, 26.

If needed, prior to the reiteration fifth reset step “E5” is implemented to switch on the screens 22, 24, 26 with their reduced brightness level, the extinction of which was forced during a previous iteration of the method.

If this is the case, this means that the voltage level “U” of the battery is below the first threshold of extinction “S2”. In this case, the least important accessory screen 26, i.e. the recreational screen 26, is switched off by the electronic control unit 30 during a sixth extinction step “E6”. It is estimated that this extinction of a screen 26 must be sufficient to maintain the battery 28 at a sufficient voltage level “U” to activate the starting device 29 the next time the vehicle is started.

The method then proceeds to a seventh verification step “E7” which is initiated by the electronic control unit 30. During this seventh verification step “E7”, the electronic control unit 30 determines if the voltage level “U” of the battery is less than a second specified threshold of extinction “S3”. The second threshold of extinction “S3” is less than the first threshold of extinction “S2”, and greater than the activation threshold “Sa”. The second threshold of extinction “S3” is equal to 11.1 V, for example.

If this is not the case, it is estimated that the battery 28 is still sufficiently charged to supply the remaining screens 22, 24 with reduced brightness without risk for the power supply of the starting device 29. The method is thus reiterated from the beginning without other action on the screens 22, 24, 26.

If needed, before the reiteration, an eighth reset step “E8” is implemented to switch on the main screen 22 and/or the comfort screen 24, with their reduced level of brightness, if their extinction was forced during a previous iteration of the method.

If this is the case, this means that the voltage level “U” of the battery is below the second threshold of extinction “S3”. In this case, the second least important accessory screen 24, i.e. the comfort screen 24, is switched off by the electronic control unit 30 during a ninth extinction step “E9”. It is estimated that this extinction of a supplementary screen 24 must be enough to maintain the battery 28 at a sufficient voltage level “U” to activate the starting device 29 the next time the vehicle is started.

The method then proceeds to a tenth verification step “E10” which is initiated by the electronic control unit 30. During this tenth verification step “E10”, the electronic control unit 30 determines if the voltage level “U” of the battery is less than a third specified threshold of extinction “S4”. The third threshold of extinction “S4” is less than the second threshold of extinction “S3”, and greater than the activation threshold “Sa”. The specified third threshold of extinction “S4” is less than all other specified threshold of extinctions “S2, S3”. The third threshold of extinction “S4” is equal to 10.9 V, for example.

If this is not the case, it is estimated that the battery 28 is still sufficiently charged to supply the main screen 22 with reduced brightness without risk for the power supply of the starting device 29. The method is thus reiterated from the beginning without other action on the screens 22, 24, 26.

If needed, before the reiteration, an eleventh reset step “E11” is implemented to switch on the main screen 22 with its reduced level brightness, if its extinction was forced during a previous iteration of the method.

If this is the case, this means that the voltage level “U” of the battery is below the third threshold of extinction “S4”. In this case, the main screen 22 is in turn switched off by the electronic control unit 30 at the twelfth extinction step “E12”. It is estimated that the extinction of the main screen 22 is necessary to maintain the battery 28 at a voltage level “U” sufficient to activate the starting device 29 the next time the vehicle is started.

Following this twelfth step “E12”, the method is reiterated.

According to a non-represented variant of the invention, during the third dimming step “E3”, the intensity of at least one of the screens 22, 24, 26 is reduced in proportion to the decrease in the voltage level of the battery from the dimming threshold up to the threshold of extinction. The brightness of the recreational screen 26 will drop faster than the brightness the main screen 22.

According to another non-represented variant of the embodiment of the invention, the brightness of at least one screen is reduced by sectors, the dimmed area of the screen being generally proportional to the drop in the intensity of the battery from the dimming threshold to associated threshold of extinction. For example, the brightness begins to decline in a banner at the top of the screen, then, as the battery voltage drops, the width of the strip increases, until it takes up the entire surface of the screen before being switched off completely by the electronic control unit.

The method for managing screens 22, 24, 26, performed according to the teachings of the invention, thus preserves the battery 28 so that the starting device 29 can be supplied with sufficient power, thereby avoiding a breakdown of the vehicle resulting in immobilization.

In addition, the gradualness of the actions undertaken on screens 22, 24, 26 according to the voltage level “U” of the battery 28 allows the driver of the vehicle to become aware of a possible charging problem of the battery 28 before the vehicle is immobilized due to drainage of the battery 28. The driver can thus take action to replace or recharge the battery 28 as a preventive measure.

1-8. (canceled)

9. A method for managing a power supply of display screens on board a motor vehicle, the vehicle including:
an onboard electric battery;
at least one vehicle starting device that is supplied with electricity by the battery, the starting device being operational only when powered by a voltage greater than or equal to an activation threshold;
at least one main screen powered by the battery;
at least one accessory screen powered by the battery;
an electronic control unit which is configure to determine the voltage level of the battery at all times;
the method comprising:
switching off the at least one accessory screen by the electronic control unit when the voltage level of the battery is less than a first specified threshold of extinction, the first threshold of extinction being greater than the activation threshold.

10. The method as claimed in the claim 9, wherein the vehicle includes a least a second accessory screen, and, when the voltage level of the battery is lower than a specified second threshold of extinction, the second accessory screen is switched off by the electronic control unit, the second threshold of extinction being between the first specified threshold of extinction and the activation threshold.

11. The method as claimed in the claim 10, wherein, when the voltage level of the battery is less than the third specified threshold of extinction, all the screens are switched off by the electronic control unit.

12. The method as claimed in the claim 11, wherein the third specified threshold of extinction is less than the first and second specified threshold of extinctions.

13. The method as claimed in the claim 12, wherein, when the voltage level of the battery is below a specified dimming threshold, a light intensity of the accessory screens is reduced by the electronic control unit, the specified dimming threshold being greater than the first, second, and third threshold of extinctions.

14. The method as claimed in the claim 13, wherein, when the voltage level of the battery is less than the dimming threshold, a light intensity of the main screens is reduced by the electronic control unit.

15. The method as claimed in the claim 13, wherein the light intensity of at least one of the screens is reduced in proportion to a decrease in the voltage level of the battery from the dimming threshold to an associated threshold of extinction of the first, second, and third threshold of extinctions.

16. The method as claimed in the claim 13, wherein a brightness of at least one of the screens is reduced by sectors, a dimmed area of each of the screens being generally proportional to a drop of the voltage of the battery from the dimming threshold to an associated threshold of extinction of the first, second, and third threshold of extinctions.
